(19) United States
(12) Patent Application Publication
(10) Pub. No.: US 2010/0237207 A1
(43) Pub. Date: Sep. 23, 2010

(54) Paint Tray Holder for Side Mount on Ladder

(76) Inventor: Manuel A. Cabral, Winnipeg (CA)

Correspondence Address: ADE & COMPANY INC., 2157 Henderson Highway, WINNIPEG, MB, R2G1P9, CA

(21) Appl. No.: 12/728,533

(22) Filed: Mar. 22, 2010

(30) Foreign Application Priority Data
Mar. 20, 2009 (CA) 2658670

(51) Int. Cl. E06C 7/14

(52) U.S. Cl. 248/211; 248/210

(57) ABSTRACT

A paint tray holder for mounting on the leg of a ladder features a mounting plate engaging a side wall of the paint tray for attachment thereto, and a support arm connected to the mounting plate to extend outwardly away therefrom to a location beneath the paint tray at a distance from the mounting plate. A tray carrying member supported on the arm member at the position beneath the paint tray extends in a direction transverse to the arm member to engage a bottom wall of the paint tray at multiple positions therealong. A clamp on the mounting plate clamps the ladder leg between stationary and movable clamping members, the movable one of which is swingable away from the stationary member and out from between adjacent rungs of the ladder to allow sliding of the holder along ladder leg for re-clamping at a different position therealong.

This application claims benefit under 35 U.S.C. 119 of Canadian Patent Application Serial No. 2,658,670, filed Mar. 20, 2009.

### FIELD OF THE INVENTION

This invention relates to a paint tray holder of the type for holding paint during painting with a brush or paint roller and is particularly designed to be mounted on a side of a ladder.

### BACKGROUND OF THE INVENTION

Often when painting internal or external walls or when painting ceilings the area to be painted is higher than an individual can reach. This usually requires the use of a ladder to enable the painter to reach the area to be painted. This creates a problem for the painter in that it requires that a brush or roller and a paint supply be utilized while standing on the ladder. Working on a ladder in this manner with a brush or roller while trying to manage a paint supply can be difficult and potentially dangerous. To help solve this problem a holding device may be used to hold the paint supply allowing the painter to have a free hand white painting. A variety of devices have been employed in this manner most of which have various drawbacks.

Hook arrangements for suspending paint cans from the rungs of a ladder have been utilized. When in use these hooks are placed on the rungs of the ladder and can get in the way of the painter when moving up and down the ladder and are not usable with paint rollers. Paint trays are also a common means of containing a paint supply. Although these trays are usable with both brushes and rollers they are also usually held on the rungs of a ladder thereby presenting the same problems when moving on the ladder.

Other prior art solutions include paint tray holders that engage over rungs of a ladder or clamp to the one of the legs or rails between which the ladder's rungs or steps extend to support the paint tray laterally outward from the ladder so as to avoid or minimize blocking of the rungs. However, drawbacks of prior art such arrangements include bulky constructions, complex installation on or repositioning along the ladder and inadequate support or balancing of paint-filled trays.

### SUMMARY OF THE INVENTION

According to a first aspect of the invention there is provided a paint tray holder for mounting a paint tray on the leg of a ladder having a plurality of rungs, said paint tray having four side walls and a bottom wall said paint tray holder comprising:
a mounting plate arranged substantially parallel to a side wall of the paint tray engaging said side wall;
an attachment means for attaching the side wall of the paint tray to the mounting plate;
a support arm connected to the mounting plate at a position below the attachment means and extending outwardly away from the mounting plate to one side thereof to a location beneath the paint tray at a distance from the mounting plate;
a tray carrying member supported on the arm member at the position beneath the paint tray and extending in a direction transverse to the arm member at the distance to the mounting plate to engage the bottom wall of the paint tray at multiple positions therealong; and
a clamp connected to the mounting plate on a side of the mounting plate opposite the tray support member, said clamp being arranged to support the paint tray on the leg of the ladder and being arranged such that the paint tray lies to one side of the ladder and clear of the rungs of the ladder.

The tray carrying member of the paint tray holder provides improved support over prior art clamping arrangements that engage the side wall of the tray but only provide bottom support thereof at a single point or location along the length of the tray while using less material for this bottom support than prior art arrangements using large-area plates disposed beneath the tray over the full length and width thereof for the tray to sit flat atop such a plate.

Preferably the support arm is movably connected to the mounting plate for selective raising and lowering of the tray carrying member relative to the mounting plate to vary a lateral angle at which the paint tray sits relative to the mounting plate in a direction transverse thereto.

The paint tray holder may comprise a support projection carried on the mounting plate and projecting therefrom to the side thereof on which the support arm extends away from the mounting plate, the support arm being pivotally connected to the support projection at a pivot point spaced from the mounting plate along the support projection for pivoting about a pivot axis transverse to a length of the support arm and the paint tray further comprising a hook member having an externally threaded stem and a curved hook end, wherein the threaded stem of the hook member passes perpendicularly through a ledge portion of the projection that is parallel to the pivot axis and the curved hook end curves through an end portion of the support arm that extends parallel to the pivot axis in the direction transverse to the length of the support arm at an end of the support arm opposite the tray carrying member, an internally threaded member being cooperatively engaged with the threaded stem of the hook member against a side of the ledge portion of the projection opposite the hook end of the hook member for selective rotation of the internally threaded member to selectively displace the threaded stem through the ledge portion to lift or lower the end portion of the support arm to pivot the support arm about the pivot axis in a respective direction to lower or raise the tray carrying member.

In this instance, preferably a coil spring is disposed about the threaded stem of the hook member between the ledge portion of the support projection and a stop collar defined on the hook member on a side of the ledge portion opposite the internally threaded member, and the threaded stem of the hook member preferably projects upward through the ledge portion of the support projection.

Preferably the tray carrying member has an upper boundary that is shaped to engage the bottom wall of the paint tray at differently sloped sections thereof.

Preferably the tray carrying member has an upper boundary that dips downward moving therealong to accommodate a reservoir of the paint tray and engage the bottom wall of paint tray both at the reservoir and elsewhere along the paint tray.

Preferably the tray carrying member comprises a plate, an upper edge of which defines the upper boundary of the tray carrying member.

Preferably a portion of the tray carrying member arranged to receive the reservoir of the paint tray is positioned proximate the clamp in a direction along which the mounting plate extends.

The tray carrying member may be releasably connected to the support arm to facilitate selective installation of differently shaped tray carrying members arranged to accommodate seating of differently shaped paint trays thereatop.

Preferably the clamp comprises a first clamping member and a second clamping member movable toward and away from the first clamping member to clamp the leg of the ladder against the first clamping member.

The second clamping member may be carried on a clamp arm that is pivotally mounted on a mounting arm carried on the mounting plate to project away therefrom on a side thereof opposite the paint carrying member, with the clamp arm being lockable in a clamping position relative to the first clamping member. Preferably the clamp arm is self locking upon pivoting into the clamping position, the clamp arm preferably comprising a projection sized for receipt in a respective hole provided in the mounting arm at a position to align with the projection with the clamp arm in the clamping position, the clamp arm being spring biased toward the mounting arm to automatically force the projection into the hole upon pivoting of the clamp arm into the clamping position. Preferably the second clamping member is movable relative to the clamp arm to tighten or loosen clamping of the ladder leg with the clamp arm in the clamping position.

The paint tray holder may be provided in combination with the paint tray, the paint tray comprising a reservoir at one end from which the bottom wall of the paint tray slopes upward and a standing support feature at an opposite end to support the opposite end when the paint tray is seated on a flat surface, the paint tray being installable on the paint tray holder or usable separate therefrom.

The tray carrying member, with the paint tray carried thereon, is preferably situated entirely to a same side of the opposite end of the paint tray as the reservoir end thereof, and preferably to a same side of the standing support feature as the reservoir end.

The standing support feature may comprise a pair of legs spaced apart along the opposite end of the paint tray, the tray carrying member of the paint tray holder being situated between the pair of legs along a width of the tray defined by said opposed end.

Components of the attachment means are preferably preinstalled on opposing ones of the paint tray and the paint tray to require no modification of the paint tray by an end-user.

According to a second aspect of the invention there is provided a paint tray holder for mounting a paint tray on the leg of a ladder having a plurality of rungs, said paint tray holder comprising:
a clamp comprising a stationary clamping member for placement against an outer lateral face of the leg of the ladder and a movable clamping member movably connected to the stationary clamping member for selective movement toward and away therefrom to engage with and disengage from an inner lateral face of the leg of the ladder opposite the outer lateral face for clamping and releasing of the leg of the ladder between the stationary and movable clamping members; and
a paint tray support connected to the clamp to project away from the stationary clamping member on a side thereof opposite the movable clamping member to support the paint tray on the leg of the ladder to one side thereof clear of the rungs when the clamp is engaged to the ladder leg;
wherein a connection between the movable clamping member and the stationary clamping member comprises a pivotal connection about which the movable clamping member is pivotable to swing the movable clamp member away from the stationary clamping member and out from between adjacent rungs of the ladder to allow sliding of the paint tray holder along the leg of the ladder for re-clamping at a different position therealong.

Prior art paint tray holders that either engage one or more rungs or engage the ladder leg between select rungs require full and complete disengagement of the entire holder from the ladder in order to reposition the holder to a new height or position along the ladder. During such removal of the device, removal of the tray or very careful and cautious handling of the holder is required to avoid spilling of paint from the tray. A paint holder of the present invention having the above mentioned swing-away clamp holder allows the holder to be simply slid along the ladder while remaining pressed thereagainst to maintain the orientation of the paint try relative to the ladder leg.

Preferably the pivotal connection comprises a pivoting clamp arm on which the movable clamping member is supported, the clamp arm being lockable in a fixed position relative to the stationary clamping member and the movable clamping member being movable relative to the clamp arm to move toward and away from the stationary clamping member with the clamp arm locked in the fixed position.

Preferably the pivotal connection is self locking upon pivoting of the clamp arm into the fixed position.

Preferably the clamp arm is spring biased to automatically lock itself in the fixed position.

Preferably the pivotal connection pivotally carries the clamp arm on a mounting arm connected to the stationary clamping member and the clamp arm comprises a projection sized for receipt in a respective hole that is provided in a mounting arm and positioned to align with the projection with the clamp arm in the fixed position, the clamp arm being spring biased toward the mounting arm to automatically force the projection into the hole upon pivoting of the clamp arm into the fixed position.

### BRIEF DESCRIPTION OF THE DRAWINGS

In the accompanying drawings, which illustrate an exemplary embodiment of the present invention:

FIG. 1 is an elevational view of a reservoir end of a paint tray carried by a paint tray holder installed on the right side of a ladder.

FIG. 2 is an elevational view of the paint tray and paint tray holder of FIG. 1 from an opposite end of the paint tray,

FIG. 3 is an elevational view of the paint tray and paint tray holder as removed from the ladder and viewed from a side of the paint tray.

FIG. 4 is an elevational view of the paint tray and paint tray holder of FIG. 3 from an opposite side of the paint tray.

FIG. 5 is an elevational view of the paint tray and paint tray holder of FIG. 3 after adjustment of a longitudinal leveling means of the paint tray holder to change a relative angle between the paint tray and a clamping mechanism of the paint tray holder.

FIG. 6 is an elevational view of the paint tray holder of FIG. 1 with the paint tray removed.

FIG. 7 a bottom plan view of the paint tray holder of FIG. 6.

FIG. 8 is an elevational view of the paint tray holder of FIG. 2 with the paint tray removed.

FIG. 9 is an overhead plan view of the paint tray holder of FIG. 8 showing a withdrawn position of a movable clamping member in broken lines.

### DETAILED DESCRIPTION

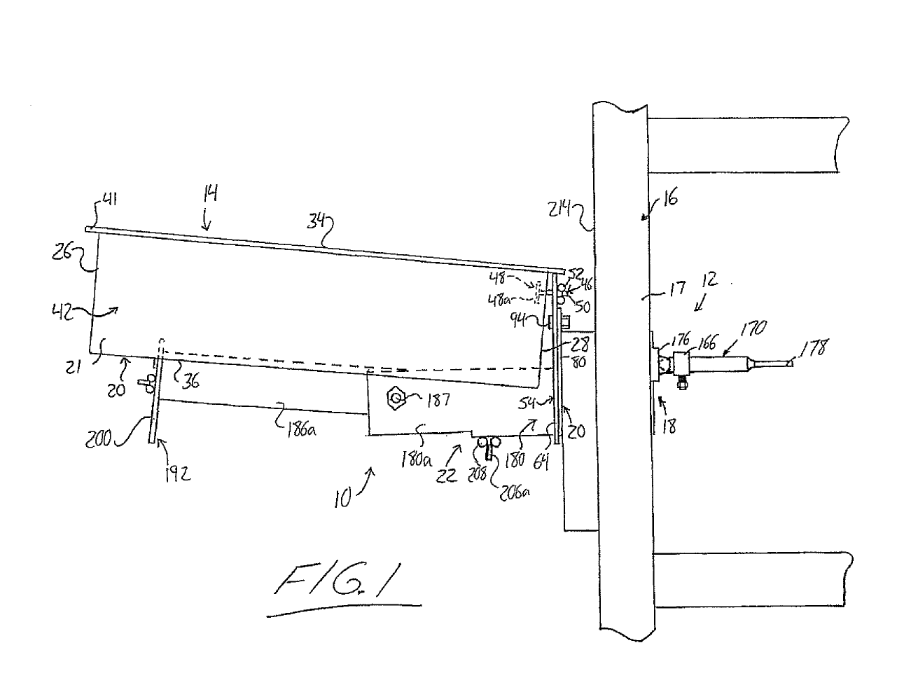

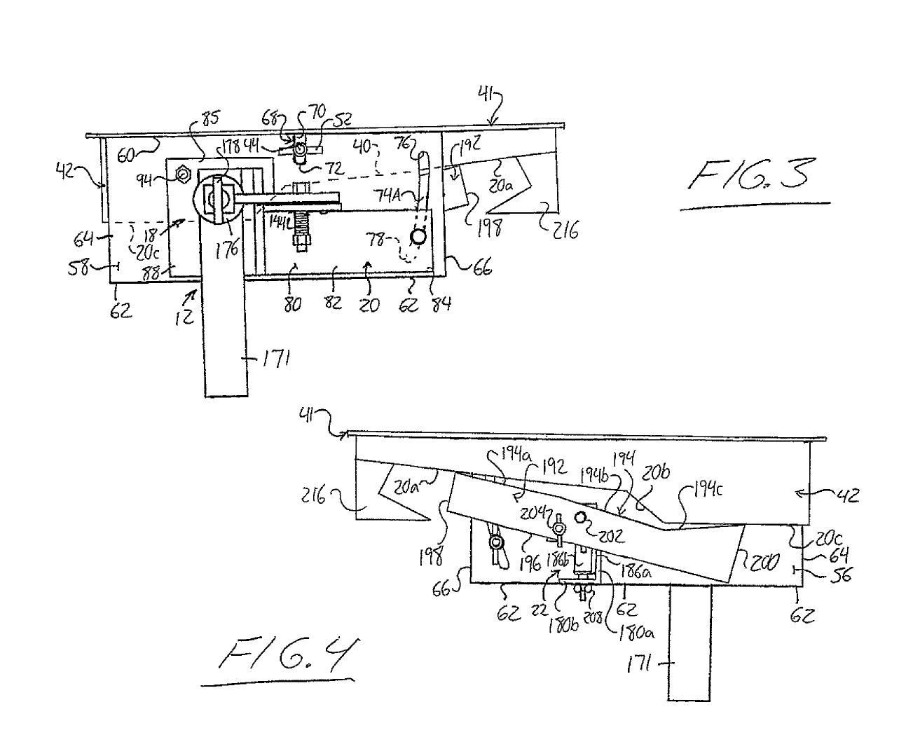

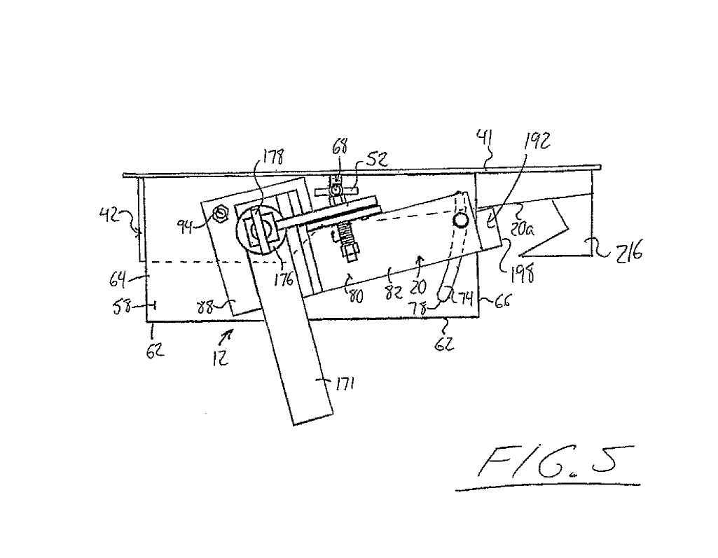

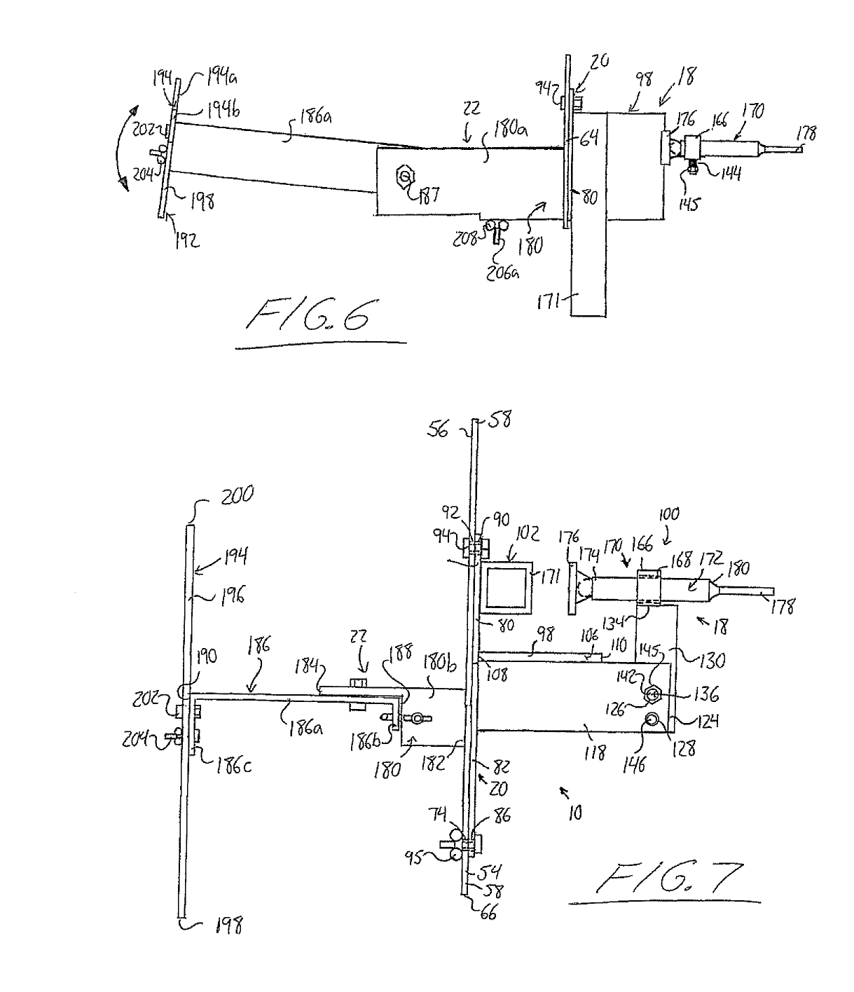

Referring to FIGS. 1 to 9 the paint tray holder is shown generally at 10. The paint tray holder 10 comprises a clamping assembly 12 for mounting a tray 14 on a ladder 16. The clamping assembly 12 comprises a clamp 18, a longitudinal leveling means 20, and a lateral leveling means 22. The clamping assembly 12 is fixed to the paint tray 14 and is secured to a leg 17 of the ladder 16 by the clamp 18.

The tray 14 is of the type for holding paint when painting with a brush or paint roller. The tray 14 has a bottom 20 and four walls, a front wall 21, back wall 24, and side walls 26 and 28. The distance from the top edge 30 of the back wall 24 to the bottom edge 32 of the back wall 24 is smaller than the distance form the top edge 34 of the front wall 21 to the bottom edge 36 of the front wall 21. The bottom 20 slopes downwards in a direction from back to front to a point 38 spaced back from the bottom edge 36 of the front wall, thereby forming a paint application surface 40. The bottom 20 then projects forward horizontally to the bottom edge 36 of the front wall forming a reservoir 42 at the front end of the tray.

The sloping portion of the bottom wall 20 of the tray 14 of the illustrated embodiment is structured as two distinctly sloped portions 20a and 20b, the first sloped portion 20a sloping linearly and obliquely downward from the bottom edge 32 of the back wall 24 at a first angle a majority of the distance to the reservoir 42 and second sloped portion 20b sloping linearly and obliquely downward from the first sloped portion 20a to the horizontal reservoir bottom 20c at over a shorter distance, and at a steeper angle, than the first sloped portion 20a. The steeper sloped section 20b defines a side of the reservoir opposite the front wall 21 to provide a distinct identifiable division between the reservoir 42 and the paint application or rolling surface 40. As is known in the art, this surface 40 may be provided with a series of transverse ridges projecting upward at spaced locations therealong.

The tray includes an outwardly projecting flange or lip 41 projecting a short distance outward from the perimeter of the tray's open top along the top edges of the front, back and side walls. The tray also 14 includes a mounting pin 46 arranged on a respective side wall 28 to receive the clamping assembly 12 when the paint tray holder 10 is mounted on the side of the ladder 16. The mounting pin 46 has a first end 48 situated inside the tray 14 and extends laterally outwards from the tray through a hole in the side wall 28 below the upper edge thereof to a second end 50. The first end features a head or plate 48a fixed thereto inside the tray 14 and sized to prevent withdrawal of the first end 48 from the tray through the hole in the side wall 28. A retaining means 52 is arranged at the second end 50 for retaining the clamping assembly 12 on the tray 14. One example of an appropriate retaining means 52 is a fastener such as a wing nut where the mounting pin 46 has a threaded shaft, for example as defined by a screw or bolt used as the pin.

The clamp assembly 12 includes a mounting plate 54 parallel to the side wall 28 of the paint tray 14 for engaging therewith. The mounting plate 54 has a front face 56 facing the paint tray 14, a rear face 58 facing away from the paint tray 14, a top edge 60, a bottom edge 62, and side edges 64 and 66 facing opposite ends of the paint tray 14. The mounting plate 54 includes a notch 68 in the top edge 60. The notch 68 has a mouth 70 and an end 72 and extends into the mounting plate 54 vertically downward from the mouth 70 to the end 72 at the top edge 60 of the mounting plate 54. The notch 68 receives a portion of the mounting pin's shaft between the paint tray side wall 28 and the retaining means 52 by lowering of the paint tray adjacently along the front face 56 of the mounting plate 54 from above and helps hold the tray 14 laterally on the clamping assembly 12 reducing the risk of the tray 14 tipping laterally of the clamping assembly 12.

The mounting plate 54 includes a slot 74 adjacent the side edge 66. The slot 74 extends through the mounting plate 54 from the front face 56 to the rear face 58 and across a substantial portion of the plate's vertical width to slot ends 76 and 78 adjacent the top and bottom edges 60 and 62 of the mounting plate 54. The slot 74 curves in a direction towards the opposite side edge 64 as it extends to its ends 76 and 78.

The clamp 18 is mounted on the mounting plate 54 by the longitudinal leveling means 20. The longitudinal leveling means 20 comprise an L shaped plate 80 arranged parallel to the mounting plate 54 on the rear side thereof. The leg 82 of the L plate 80 extends from a first end 84 adjacent the side 66 of the mounting plate 54 along the bottom edge 62 of the mounting plate 54 in a direction towards the side 64 of the mounting plate 54. The foot 88 extends from adjacent the bottom edge 62 upwards to a second end 85 spaced downward from the top edge 60 of the mounting plate 54. The leg 82 of the L plate 80 has a hole 86 through the first end 84 arranged to lie over the slot 74 in the mounting plate 54. A second hole 90 extends through the foot 88 adjacent the second end 85 of the L plate 80. The second hole 90 is arranged to align with a hole 92 in the mounting plate 54 lying nearer side edge 64 of the mounting plate 54 than opposite side edge 66.

The mounting plate 54 is pivotally connected to the L plate face-to-face therewith by a pin 94 extending through the aligned holes 90 and 92. The arcuate shape of the slot 74 in the mounting plate 54 is centered on the axis of this pin 94. The pivot connection allows the mounting plate 54 to slide relative to the L plate 80. Pivotal movement of the plates 54 and 80 is restrained by a or removable and reengageable fastener 95 arranged through the slot 74 and the first hole 86. The removable and reengageable fastener 95 when tightened prevents movement of the mounting plate 54 relative to the L plate 80 and allows sliding movement of the mounting plate relative to the L plate 80 when loosened by clamping and releasing the plates into and out of frictional engagement with one another respectively. One example of an appropriate removable and reengageable fastener is a bolt and wing nut.

Referring to FIG. 9, the clamp 18 is fixed to the longitudinal leveling means 20 and comprises a clamping mechanism 100 and a stationary clamping member 102. The clamping mechanism 100 includes a side plate 98 of the clamp 18 has a top edge 104, a bottom edge 106, and side edges 108 and 110. The side plate 98 is fixed to the L plate 80 along one of its side edges 108 and is arranged perpendicular to the L plate 80 extending rearwards therefrom.

The clamp 18 has a closed side 114 provided the side plate 98. The closed side 114 helps to align the leg 17 of the ladder 16 within the clamp 18. The clamp 18 also has an open side 116 opposite the closed side 114 to receive the leg 17 therethrough. The direction running from the open side to the closed side is the direction of insertion into the clamp 18. When the paint tray holder 10 is mounted on a ladder the direction of insertion runs perpendicular to a line running longitudinally through the rungs of the ladder. The direction running perpendicular to the direction of insertion is the direction of clamping action.

The clamping mechanism 100 also includes a support plate 118 fixed to the L plate 80 at a first end 120 and fixed along one side 122 to the side plate 98 on a face of the side plate 98 facing the side edge 66 of the mounting plate 54. The support plate 118 extends past the end of the side plate 98 to a free end 124. A pivot hole 126 extends through the support plate 118 adjacent the free second end 124 thereof. An additional through hole 128 is provided in the support plate 118 to one side of the pivot hole 126 at an aligned position therealong adjacent the free second end 124.

A clamp arm 130 comprises an elongate member having a first end 132 and a second end 134, and is connected to the support plate 118 at its first end 132. The clamp arm 130 is connected to the support plate 118 for pivotal movement about the axis of the pivot hole 126. A bolt 136 extends from a first end 138 through a hole 140 in the clamp arm 130 and through the pivot hole 126 in the support plate 118 to a second end 142. A coil spring 144 is arranged around the bolt 136 between the support plate 118 and a nut 145 fitted on the bolt 136 proximate the second end 142 thereof. The coil spring 144 biases the clamp arm 130 towards the support plate 118. A projection 146 is fixed to the clamp arm 130 and is arranged to engage within the hole 128 in the support plate 118 securing the clamp arm at a fixed position relative to the fixed-together support plate 118 and L-plate 80.

Applying a force to the clamping arm 130 in a direction away from the support plate 118 frees the projection 146 from the hole 128 and allows the clamping arm 130 to pivot about the hole 126 in the support plate 118. Removing the force from the clamping arm 130 when the clamping arm 130 is repositioned back over the hole 128 causes the clamping arm 130 to be biased back towards the support member 118 and reengages the projection 146 within the hole 128 to once again secure the clamping arm 130 in place.

A mounting member 166 is located at the second end 134 of the clamping arm 130. The mounting member 166 includes a threaded hole 168 extending therethrough perpendicular to the length of the support plate 118 measured between the opposing ends 132, 134 thereof. A movable clamping member 170 is arranged through the hole 168. The stationary clamping member 171 comprises a hollow rectangular tube fixed to the L plate 80 such that it aligns with the threaded hole 168 in the mounting member 166 when the clamp arm 130 is in its locked position engaging the projection 146 in the hole of the support arm 118.

The movable clamping member 170 comprises a threaded elongate member 172 which is round in cross section and extends through the threaded hole 168 in the mounting member 166 to an end 174 lying between the clamping arm 130 and the stationary clamping member 171 with the clamp arm 130 in the fixed position. The threaded elongate member 172 has a flat plate 176 arranged at said end 174, and a handle 178 arranged at an end 180 opposite for rotating the elongate member 172. With the clamp arm 130 in the fixed position, rotating the elongate member 172 in a first direction causes the flat plate 176 to be linearly displaced towards the stationary clamping member 171 and rotating the elongate member in a second direction causes the flat plate 176 to be linearly displaced away from the stationary clamping member 171.

With the clamping arm automatically locked in a fixed clamping position relative to the stationary clamping member 171 by the biasing of the clamping arm's projection into the respectively sized and positioned hole in the support plate 118, the threaded elongate member 172 is movable toward and away from the fixed clamping member 171 to clamp the leg of the ladder thereagainst. To install the paint tray holder on a ladder, the threaded elongate member is rotated in a loosening direction to pull the clamping plate 176 back to mounting member 166, or sufficiently theretoward to accommodate the ladder leg between the clamping plate 176 and the fixed clamping member 171. If additional room is needed to accommodate the cross-sectional shape of the ladder leg, for example to insert a portion thereof into the space left between the fixed clamping member 171 and the side plate 98, then the clamp arm 130 can be raised to release the projection from the hole in the support plate 118 and unlock the clamp arm, which is then pivoted to move away from the fixed clamping member 171. Once the ladder leg is in place with the stationary clamping member 171 placed face-to-face against the outer lateral face or side of the ladder leg, the clamp arm 130 is moved back into its self locking clamping position and the threaded member 172 is then tightened to press the clamping plate 176 against the inner lateral face or side of the ladder leg to hold the paint tray holder in place.

Should it later be desirable to move the holder along the ladder, for example to move further up the ladder leg for painting of more elevated areas, unlocking and pivoting of the clamp arm 130 away from the ladder leg provides a quick-release function freeing the clamping of the ladder leg and swinging the clamp arm 130, mounting member 166 threaded elongate member 172 and clamping plate 176 out from between adjacent rungs on the ladder. Through manual support of the holder, for example by gripping the stationary clamping member 171 to keep it pressed along the outer face of the ladder leg, the ladder leg is maintained against the side plate 98 and fixed clamping member 171 and manually slid up along the ladder leg to a new desirable position, at which point manual pivoting of the clamp arm 130 back to into its locked condition to once again engage the clamping plate 176 against the ladder leg to secure the holder in its new position further up the ladder with only minimal, if any, rotation of the elongate threaded member 172 being required through this repositioning process.

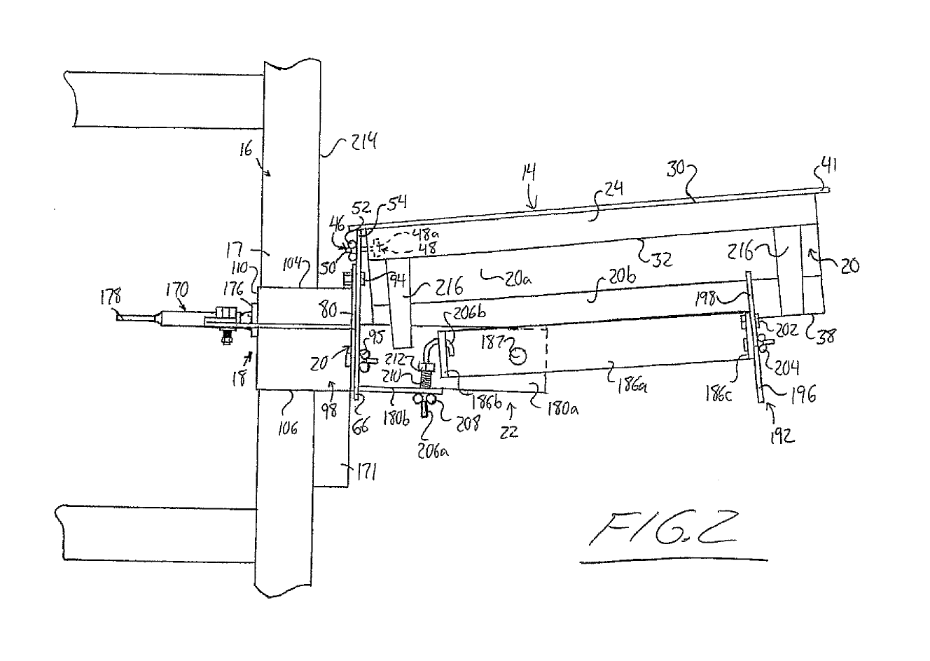

FIG. 9 shows, in broken lines, the clamp arm 130 pivoted one hundred and eighty degrees from the fixed clamping position perpendicular to the support plate 118 so that the clamp arm 130 and all components carried thereon do not extend past the side plate 98 to the side thereof on which the stationary clamping member 171 is disposed. This thus completely withdraws ail the moving clamping components from between rungs of the ladder when the clamp arm 130 is pivoted to the broken line position of FIG. 9 from its previous clamping position on the ladder (FIGS. 1 and 2). In other embodiments, the pivot angle to which the clamp arm 130 is swung to complete the withdrawal of the movable clamping member from between the ladder rungs and legs need not necessarily be one hundred and eighty degrees. Also, it will be appreciated that same locking function used to secure the swing arm 130 in the fixed position can similarly be used to maintain the swing arm 130 in the withdrawn position during sliding repositioning or initial installation on the ladder by providing a second through hole at an equal radial distance from, but different angular position around, the pivot hole 126 as the illustrated through hole 128 in order to align with the clamp plate projection 146 with the clamp arm 130 in the withdrawn position and receive the projection 146 under the bias of the coil spring 144. In the illustrated embodiment where the fixed and withdrawn positions of the clamp arm 130 are one hundred and eighty degrees apart, the second hole would be diametrically opposite the illustrated hole 128 across the pivot hole 126.

The lateral leveling means 22 are fixed to the front side of the mounting plate 54 and projects under the tray 14 to support the tray 14 from below and allow the tray 14 to be angled laterally, thereby adjusting the lateral level of the tray 14. The lateral leveling means 22 comprise a projecting support member 180 having a first end 182 and a free second end 184. The support member 180 is fixed to the mounting plate 54 at the first end 182 and extends perpendicular to the mounting plate 54 and laterally forwards therefrom to the second end 184. From its first end 182 to a point part way between its opposite ends, the support projection 180 has an L-shaped or right angle cross-section defining an upwardly extending wall portion 180a parallel to the side edges 64, 66 of the rectangular mounting plate 54 and a ledge portion 180b parallel to the top and bottom edges 60, 62 of the mounting plate. Only the upstanding wall portion 180a extends and defines the full length of the projecting support member 180 between its opposing ends 182, 184.

A support arm 186 has a pivotal connection 187 to the support member 180 proximate the free end 184 on the upstanding wall portion 180a past the end of the ledge portion 180b. The support arm 186 extends to opposite ends 188, 190 on opposite sides of the pivotal connection 187, extending forwardly away from the mounting plate 54, that is, to the side thereof opposite the clamp 18, from its first end 188 nearest the mounting plate 54 to its second end 190 thereopposite. The support arm 186 has a squared off U-shape, having a central a plate-like central portion 186a defining a longitudinal direction of the arm extending laterally away from the mounting plate 54 in a plane normal thereto, and first and second end portions 186b, 186c projecting from a common face of the central portion 186 to a common side thereof in parallel planes normally transverse thereto. In the illustrated embodiment, the arm is an integral piece having bent end portions with top and bottom edges each spanning all three sections of the U-shaped piece.

A tray carrying member 192 is provided by an elongate plate fixed face-to-face against the second end portion 186c of the support arm 180 to lie in a plane perpendicular to that of the support arm's central portion 186a and project from both sides thereof. When the paint tray is lowered into engagement with the mounting plate 54, that is to lower the pin 44 of the paint tray into the slot-shaped notch 70 in the top of the mounting plate 54 and seat the optional flange, rim or lip 41 of the tray on the top edge 60 of the mounting plate, the tray carrying member 192, the bottom wall 20 sits atop an upper edge 194 of the tray carrying member 192 at a distance from the mounting plate near the opposite side wall 26 of the paint tray 14.

A bottom edge 196 of the illustrated tray carrying plate 192 is linear, with opposing end edges 198, 200 of the carrying plate 192 being parallel to one another and perpendicular to the bottom edge 196. From the first end 198 of the tray carrying plate nearest the side edge 66 of the mounting plate 54 adjacent which the slot 74 is formed, the linear bottom edge 196 of the carrying plate 192 slopes obliquely downward relative to the bottom edge 62 of the rectangular mounting plate 54, this angle defining a longitudinal direction or lengthwise dimension of the carrying plate 192 that generally follows along the bottom wall of the paint tray at a distance therebelow. The top edge 194 however is not linear from end to end, but is instead shaped to cooperate with the shape of the paint tray's bottom wall 20 to engage thereagainst at different positions therealong. From the first end 198 of the tray carrying plate nearest the side edge 66 of the mounting plate adjacent which the slot 74 is formed, a first portion 194a of the top edge 194 of the carrying plate extends parallel to the bottom edge 196. A second portion 194b of the top edge 194 slopes obliquely downward relative to the first portion 194a from proximate where the carrying plate 192 connects to the support arm 186. A third portion 194c of the top edge 194 is obliquely sloped relative to the second portion 194b from which it extends, and slopes obliquely away from the bottom edge 196.

The second and third portions 194b, 194c of the top edge of the carrying plate 192 meet below the bottom wall 20 of the paint tray 14 at or proximate the point 38 at which the horizontal and steepest portions 20c, 20b of the tray's bottom wall 20 meet. The third portion 194c of the carrying member's top edge 194 contacts the tray's bottom wall 20 at the horizontal portion 20c thereof defining the reservoir bottom and the first portion 194a contacts the tray's bottom wall 20 at the first sloped section 20a extending from the rear wall 24 of the tray opposite the reservoir 42. In the illustrated embodiment, the angles of the tray carrying plate are such that it contacts the paint tray 14 at only these two points, with the rest of the carrying's plate's upper edge 194 spaced below the tray, thereby leaving room to accommodate variations in the shaping of different paint trays.

A bolt 202 passed perpendicularly through the parallel face-to-face carrying plate 192 and support arm second end portion 186c provides a pivot axis transverse to the carrying plate 192 for pivoting of the carrying plate 192 relative to the support arm 186 on which it is carried. A tightenable and loosenable fastener 204, such as a bolt and wing-nut combination, passes through overlapping holes the carrying plate 192 and the second end portion 186c of the support arm parallel to the bolt 202, one of these holes being a slot of arcuate shape curving about the axis of the bolt 202, or at least being sufficiently large to accommodate arcuate motion of the fastener about that axis. With the fastener loosened, the carrying plate 192 can thus be pivoted to reorient its lengthwise dimension at a new angle relative to the support arm 186. Alternatively, the carrying plate 192 and support arm 186 may instead be arranged to interconnect at a fixed non-adjustable angle.

The bolt 202, or equivalent pivot providing component, may also use a bolt and wing-nut combination or other removable arrangement to allow removal of the carrying plate 192 and thereby facilitate replacement of a carrying plate 192 of one shape with any one of differently shaped carrying plates each arranged for better. It will be appreciated that a single-fastener arrangement may replace the use of separate pivoting and tightening components and still facilitate one or both of a pivotal carrying plate and removable carrying plate arrangement. Where the paint tray holder is intended for use with a particular tray, the carrying plate 192 may be shaped to contour the plate's upper edge to more closely conform to shape of that particular type of tray.

The pivotal connection 187 of the support arm 186 to the support projection 180 uses a bolt or other pivot pin structure passing perpendicularly through the upright wall portion 180a of the support projection 180 and the central portion 186a of the support arm sitting parallel and adjacent thereto to provide a pivot axis perpendicularly transverse to the length-defining central portion 186a of the support arm. An adjustment device operable to change an angle at which the tray bottom 20 is oriented relative to the mounting plate 54 in a vertical plane perpendicular to the mounting plate to facilitate removal of lateral tilt of the tray for leveling thereof uses a hook member 206 connected between the support projection 180 and the support arm 186 on the same side of the pivotal connection 187 therebetween as the mounting plate 54 to pivot the support arm 186 to raise or lower the tray carrying member 192 on the opposite side of the pivotal connection 187.

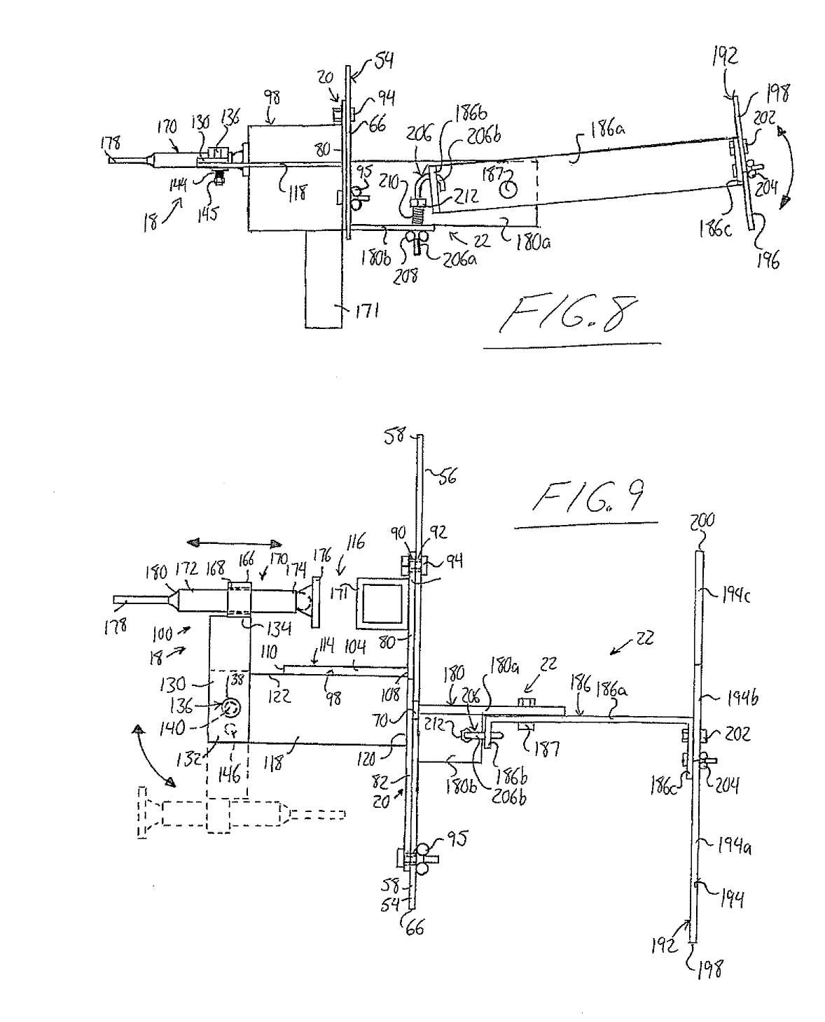

As best shown in FIG. 8, the hook member 206 consists of an externally threaded and linearly extending stem portion 206a with an integral hook portion 206b at an end thereof curving back along itself toward the stem. The threaded stem portion 206a is vertically oriented parallel to the mounting plate 54 and passes upward through a hole in the ledge portion 180b of the support projection 180 to situate the hook portion 206b above this ledge. The hook portion 206b curves through a hole in the first end portion 186b of the support arm 186, which is situated above the ledge 180b proximate the end thereof opposite the mounting plate 54. Below the ledge 180b of the support projection 180, the threaded stern of the hook member 206 is cooperatively engaged by an internally threaded and manually rotatable fastener 208, such as a wing nut. Tightening of the wing nut draws the stem 206a of the hook member 206 further downward through the ledge 180b, simultaneously pulling the hook portion 206b and the first end 186b of the support arm 186 through which it passes downward toward the ledge 180b situated below the support arm 186 at the bottom edge 62 of the mounting plate 54, thereby lifting the tray carrying member 192 at the second end portion 186c of the support arm 186 on the opposite side of the pivot 187.

A coil spring 210 is disposed around the threaded stem 206a of the hook member 206 between the ledge 180b of the support projection 180 and a nut 212 fitted on the threaded stem 206a thereabove proximate the end of the threads adjacent the hook portion 206b to define a stop collar projecting radially outward from the hook stern. The coil spring 208 and the weight of the carrying member 192 on the side of the pivot 187 opposite the hook member 206 bias the first end 186b of the support arm upward, thereby forcing the wing nut 208 up against the bottom face of the ledge 208b. Loosening the wing nut 208 allows the hook stem to rise further upward through the ledge 208b to raise the hook portion 206b and the support arm's first end 186b connected thereto, thereby pivoting the support arm 186 to lower the tray carrying member 192. The hook member and the holes through which it passes are suitably sized to accommodate the relative motion therebetween necessary to facilitate sufficient pivoting of the support arm to address lateral leveling of the paint tray required during usage of different ladder types in typical conditions.

In use of the paint tray holder, a leg 17 of the ladder 16 is placed within the clamp 18 such that the stationary clamping member 171 engages an outer lateral face 214 of the leg 17 with the lateral leveling means 22 extending laterally away from the ladder 16. The clamp 18 is tightened onto the ladder 16 by turning the handle 178 of the movable clamping member 170, with the clamp arm 130 locked in its fixed clamping position. The tray 14 is then positioned on top of the tray carrying member 192 of the lateral leveling means 22 such that the mounting pin 46 engages within the notch 68 in the clamp 18. The lateral level is adjusted by turning the wing nut 208 on the lateral leveling means 22. The longitudinal level is adjusted by loosening the removable and reengageable retaining means 95 and sliding the mounting plate 54 relative to the L plate 80. The removable and reengageable retaining means 95 are then tightened securing the mounting plate 54 relative to the L plate 80. The retaining means 52 on the mounting pin 46 are then tightened, securing the tray 14 in position on the clamp 18.

The paint tray holder may be sold on its own, or as part of a kit including at least one paint tray having been equipped with a hole, notch or slot for receiving the pin 46 at the factory so that no tray modification needs to be performed by the distributor, consumer or end-user to produce the operable attachment means between the tray and mounting plate. An alternate tray produced for sale or use with the paint tray holder may alternatively include a fixed pin or shaft permanently pre-installed on the side wall of the tray at the factory. A further alternative embodiment would feature a pin or shaft factory installed on the mounting plate, either permanently fixed thereto or fastened thereto through a hole, notch or shaft, with the retaining means then secured to the end of the shaft to received inside the tray through a hole, notch or shaft formed in the paint tray.

As shown in the illustrated embodiment, the paint tray 14 may include a pair of spaced apart support legs 216 depending downward from the bottom wall 20 of the tray 14 at or proximate the back wall 24 with bottoms of the support legs or feet 216 coplanar with the bottom surface of the reservoir bottom 20c so that the tray will sit flat on a horizontal surface to situate the planar upper end of the tray horizontally so that the tray can be used in contexts other than with the paint tray holder of the present invention. In other words, the support legs stand or elevate the back end of the tray opposite the reservoir above a flat generally horizontal surface on which the tray is placed to level the planar top of the tray. In the illustrated embodiment, the legs 216 are adjacent but spaced slightly inward from opposite side walls of the paint tray, with the tray carrying member 192 located between the legs along the width of the tray defined by the equally long front and back end walls thereof. The carrying member 192 may instead engage the bottom wall of the tray outside the leg furthest from the mounting plate 54, and as illustrated, may be situated entirely to the same side of the legs as the opposite reservoir end of the tray to avoid interference between the legs of the tray and the tray carrying member of the tray holder.

Although the illustrated embodiment is shown installed on a right leg of a ladder, a mirrored configuration of the paint tray holder may be used in the same manner on the ladder leg on the opposite side of the rungs, cooperating with a paint tray having a pin instead or additionally located on the opposite side wall. Trays produced for particular use with different paint tray holders of the present invention may include pins on both sides for use on either side of a ladder depending on which holder is used. An embodiment of the paint tray holder may use re-configurable components for selective use on either ladder leg and still employ features of the present invention that are advantageous over prior art paint tray holders.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A paint tray holder for mounting a paint tray on the leg of a ladder having a plurality of rungs, said paint tray having four side walls and a bottom wall said paint tray holder comprising:
a mounting plate arranged substantially parallel to a side wall of the paint tray engaging said side wall;
an attachment means for attaching the side wall of the paint tray to the mounting plate;
a support arm connected to the mounting plate at a position below the attachment means and extending outwardly away from the mounting plate to one side thereof to a location beneath the paint tray at a distance from the mounting plate;
a tray carrying member supported on the arm member at the position beneath the paint tray and extending in a direction transverse to the arm member at the distance to the mounting plate to engage the bottom wall of the paint tray at multiple positions therealong; and
a clamp connected to the mounting plate on a side of the mounting plate opposite the tray support member, said clamp being arranged to support the paint tray on the leg of the ladder and being arranged such that the paint tray lies to one side of the ladder and clear of the rungs of the ladder.

2. The paint tray holder according to claim 1 wherein the support arm is movably connected to the mounting plate for selective raising and lowering of the tray carrying member relative to the mounting plate to vary a lateral angle at which the paint tray sits relative to the mounting plate in a direction transverse thereto.

3. The paint tray holder according to claim 2 comprising a support projection carried on the mounting plate and projecting therefrom to the side thereof on which the support arm extends away from the mounting plate, the support arm being pivotally connected to the support projection at a pivot point spaced from the mounting plate along the support projection for pivoting about a pivot axis transverse to a length of the support arm and the paint tray further comprising a hook member having an externally threaded stem and a curved hook end, wherein the threaded stem of the hook member passes perpendicularly through a ledge portion of the projection that is parallel to the pivot axis and the curved hook end curves through an end portion of the support arm that extends parallel to the pivot axis in the direction transverse to the length of the support arm at an end of the support arm opposite the tray carrying member, an internally threaded member being cooperatively engaged with the threaded stem of the hook member against a side of the ledge portion of the projection opposite the hook end of the hook member for selective rotation of the internally threaded member to selectively displace the threaded stem through the ledge portion to lift or lower the end portion of the support arm to pivot the support arm about the pivot axis in a respective direction to lower or raise the tray carrying member.

4. The paint tray holder according to claim 3 comprising a coil spring disposed about the threaded stem of the hook member between the ledge portion of the support projection and a stop collar defined on the hook member on a side of the ledge portion opposite the internally threaded member.

5. The paint tray holder according to claim 3 wherein the threaded stem of the hook member projects upward through the ledge portion of the support projection.

6. The paint tray holder according to claim 1 wherein the tray carrying member has an upper boundary that is shaped to engage the bottom wall of the paint tray at differently sloped sections thereof.

7. The paint tray holder according to claim 1 wherein the tray carrying member has an upper boundary that dips downward moving therealong to accommodate a reservoir of the paint tray and engage the bottom wall of paint tray both at the reservoir and elsewhere along the paint tray.

8. The paint tray holder according to claim 6 wherein the tray carrying member comprises a plate, an upper edge of which defines the upper boundary of the tray carrying member.

9. The paint tray holder according to claim 1 wherein a portion of the tray carrying member arranged to receive a reservoir of the paint tray is positioned proximate the clamp in a direction along which the mounting plate extends.

10. The paint tray holder according to claim 7 wherein a portion of the tray carrying member arranged to receive the reservoir of the paint tray is positioned proximate the clamp in a direction along which the mounting plate extends.

11. The paint tray holder according to claim 1 wherein the tray carrying member is releasably connected to the support arm to facilitate selective installation of differently shaped tray carrying members arranged to accommodate seating of differently shaped paint trays thereatop.

12. The paint tray holder according to claim 1 wherein the clamp comprises a first clamping member and a second clamping member movable toward and away from the first clamping member to clamp the leg of the ladder against the first clamping member, wherein the second clamping member is carried on a clamp arm that is pivotally mounted on a mounting arm carried on the mounting plate to project away therefrom on a side thereof opposite the paint carrying member and the clamp arm is lockable in a clamping position relative to the first clamping member.

13. The paint tray holder according to claim 12 wherein the clamp arm is self locking upon pivoting into the clamping position.

14. The paint tray holder according to claim 13 wherein the clamp arm comprises a projection sized for receipt in a respective hole provided in the mounting arm positioned to align with the projection with the clamp arm in the clamping position, the clamp arm being spring biased toward the mounting arm to automatically force the projection into the hole upon pivoting of the clamp arm into the clamping position.

15. The paint tray holder according to claim 12 wherein the second clamping member is movable relative to the clamp arm to tighten or loosen clamping of the ladder leg with the clamp arm in the clamping position.

16. The paint tray holder according to 1 in combination with the paint tray, the paint tray comprising a reservoir at one end from which the bottom wall of the paint tray slopes upward and a standing support feature at an opposite end to support the opposite end when the paint tray is seated on a flat surface, the paint tray being installable on the paint tray holder or usable separate therefrom.

17. The combination according to claim 16 wherein the tray carrying member, with the paint tray carried thereon, is situated entirely to a same side of the opposite end of the paint tray as the reservoir end thereof.

18. The combination according to claim 16 wherein the standing support feature comprises a pair of legs spaced apart along the opposite end of the paint tray, the tray carrying member of the paint tray holder being situated between the pair of legs along a width of the tray defined by said opposed end.

19. The combination according to claim 16 wherein components of the attachment means are preinstalled on opposing ones of the paint tray and the paint tray to require no modification of the paint tray by an end-user.

20. A paint tray holder for mounting a paint tray on the leg of a ladder having a plurality of rungs, said paint tray holder comprising:
a clamp comprising a stationary clamping member for placement against an outer lateral face of the leg of the ladder and a movable clamping member movably connected to the stationary clamping member for selective movement toward and away therefrom to engage with and disengage from an inner lateral face of the leg of the ladder opposite the outer lateral face for clamping and releasing of the leg of the ladder between the stationary and movable clamping members; and
a paint tray support connected to the clamp to project away from the stationary clamping member on a side thereof opposite the movable clamping member to support the paint tray on the leg of the ladder to one side thereof clear of the rungs when the clamp is engaged to the ladder leg;
wherein a connection between the movable clamping member and the stationary clamping member comprises a pivotal connection about which the movable clamping member is pivotable to swing the movable clamp member away from the stationary clamping member and out from between adjacent rungs of the ladder to allow sliding of the paint tray holder along the leg of the ladder for re-clamping at a different position therealong.
